(19) United States
(12) Patent Application Publication
(10) Pub. No.: US 2023/0073320 A1
(43) Pub. Date: Mar. 9, 2023

(54) Automatic Backup Power Controller for Aquarium Use

(71) Applicant: Todd Haynes, Knoxville, MD (US)

(72) Inventor: Todd Haynes, Knoxville, MD (US)

(21) Appl. No.: 17/940,903

(22) Filed: Sep. 8, 2022

Related U.S. Application Data
(60) Provisional application No. 63/241,956, filed on Sep. 8, 2021.

(51) Int. Cl. H02J 9/06; H02J 7/00; A01K 63/04

(52) U.S. Cl. CPC H02J 9/061; A01K 63/047; H02J 7/0047

(57) ABSTRACT

An automatic backup power controller for aquarium use. When the Backup Box taught by the present invention has normal power applied to it, it energizes the 12-24 volt DC coil and closes the Normally Open side of the relay which sends 12-24 volts through the relay and to the connected pump or power head that is connected to the output port on the Backup Box. When normal power is lost the coil will DE-energize thus opening the Normally Open side of the relay in turn causing the Normally Closed side of the relay to close and send 12-24 volts DC battery power through the Normally Closed side of the relay through the fuse and to the Output connection on the Backup Box. The Output connection on the Backup Box is common to both the Normally Open and Normally Closed terminals on the Relay depending on the state it is in.

### FEDERALLY SPONSORED RESEARCH

Not Applicable

### SEQUENCE LISTING OR PROGRAM

Not Applicable

### TECHNICAL FIELD OF THE INVENTION

The present invention relates to aquariums, and other bodies of water containing aquatic life. More particularly, the invention relates to a backup battery power control system for providing uninterrupted power to aquarium devices and automatic switching between power sources so as to avoid power interruption.

### BACKGROUND OF THE INVENTION

Fish consume oxygen and produce carbon dioxide. Most of the oxygen enters the aquarium (and co2 leaves the aquarium) by gas exchange at the water surface. The excess co2 gasses off into the room and fresh oxygen enters the water. With good air exchange the aquarium reaches equilibrium with the levels in the air around the tank, and for the most part, doesn’t vary too much. Good air exchange is the result of good flow in the tank and agitation at the surface of the tank. When the power goes out, so does most of this gas exchange. This isn’t a huge issue for most aquariums if we’re talking about a short period of time, but the sooner the water movement and surface agitation back up and running the better.

An outage that lasts three hours or more could become problematic for an aquarium. This is because most modern aquariums use electricity to run all of the essential parts that keep it stable, like pumps, filters, heaters, and lights mentioned before. Without electricity to keep all of those moving parts functioning, the environment in an aquarium can become unsettled very quickly. Without power, the most common issues to occur in an aquarium include: Oxygen depletion where fish will still consume oxygen in the aquarium, even if that oxygen isn’t being replaced with the help of the filter, as the aquatic life in your tank slowly uses up what’s left, a dangerous oxygen depletion will start to occur; Water temperature variation where most aquatic species need water temperatures of 72 to 82° F. to remain healthy, changes in water temperature may stress fish, which then puts them at risk for disease. Additionally, as temperatures rise in the aquarium, water begins to lose its capacity to hold oxygen; and ammonia buildup, where without a working filtration system, the ammonia in an aquarium could reach levels that are toxic to fish and other aquatic life forms.

Fortunately, in most cases the power is only out for a few hours, though depending on location and the magnitude of the cause, outages can turn into days, weeks, or even months. Prolonged or repeated outages to circulation and lighting can have a dramatic effect on the fragile ecosystems of most tanks. Heaters, aerators, filtration systems-all need electrical power to operate and keep fish alive. They need heat when it is cold, cold when it is hot, and oxygen to breathe at all times. Therefore, it is preferred that such outages be avoid completely or minimized to reduce the impact on aquatic ecosystems.

What is needed is an automatic backup power controller for aquarium use that eliminates the need for inverters, transformers, and replaces the common 12 volt systems with a directly compatible 24 volt DC system.

Many DIY universal Battery backup systems known and available in the prior art require an inverter, starter relay, and require 120 volts. What is needed is a battery backup system that can run on lower, DC voltages when 12 volt standard power is unavailable or interrupted while also eliminating the need for an inverter and starter relay.

Other aquarium pump backup systems require a sensor, a second back up pump, an additional canister aquarium filter, and a microswitch. These prior art solutions are very complicated designs and use many different parts. Therefore, what is needed is a device for providing an aquarium backup system that uses no sensors or switches and does not require secondary or backup pumps and filters but is designed to use the main filters and pumps in a simple circuit design and works in an autonomous fashion.

### SUMMARY OF THE INVENTION

The present invention teaches an automatic backup power for aquarium use. The present invention is an all in one unit that will automatically switch over to battery backup power if the loss of normal plug in receptacle power from events such as a power outage. It has been designed for use with today’s more energy efficient 12-24 volt DC aquarium pumps which are powered through “power bricks” which take a home’s normal 120 volt AC power and transforms it to 12-24 volts DC.

Aquarium hobbyists are always searching for an effective way to keep water moving throughout their aquarium in order to keep oxygen supplied to their Fish, Coral, and inverts. In aquariums keeping the water constantly moving is necessary in keeping the aquarium inhabitants alive. Some aquarium hobbyists go to great lengths and expenses in order to this by purchasing backup generators and in some cases even whole house generators.

The Backup Box as taught and claimed by the present invention is an aquarium hobbyist dream come true as the loss of normal power will cause it to automatically switch over to battery backup power that the hobbyist configures to meet their own demand. The Backup Box as taught and claimed by the present invention with any 12-24 volt AH battery setup, and it is not a propitiatory system, so it works on any 12-24 volt pump or wave maker.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and form a part of the specification, illustrate the present invention and, together with the description, further serve to explain the principles of the invention and to enable a person skilled in the pertinent art to make and use the invention.

FIG. 1 is sketch of the battery backup box layout of the present invention and the component parts.

FIG. 2 is sketch of the backup box relay as taught by the present invention.

FIG. 3 is a sketch of the battery box wiring for one exemplary embodiment of the present invention.

FIG. 4 is a front side, bottom side, and right side sketch of the outside of the backup box taught by the present invention illustrating the inputs, outputs, and displays of one exemplary embodiment of the present invention.

FIG. 5 is a sketch of the internal components and wiring of the backup box of one exemplary embodiment of the present invention.

FIG. 6 is sketch of the backup box relay as taught by the present invention.

FIG. 7 is a sketch of the battery box wiring for one exemplary embodiment of the present invention.

FIG. 8 is a picture of a prototype battery backup box as mounted to a wall during testing showing the front side display and status indicating lights.

FIG. 9 is a picture of a prototype battery backup box as mounted to a wall during testing showing the bottom side input and output connections.

FIG. 10 is a picture of a prototype battery backup box as mounted to a wall during testing showing the front side display and status indicating lights, left side feed mode button, and bottom side input and output connections.

FIG. 11 is a picture of a prototype battery backup box as mounted to a wall during testing showing the connection to a batter pack and integration with an automatic batter charging system.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized, and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The device of the present invention is an automatic backup power controller for aquarium use. The present invention is distinguishable over prior art system, which incorporated uninterrupted power supplies (UPS), invertors, batteries, and related combinations unsuccessfully. The present invention is a 24 volt system, unlike the various attempted prior art solutions which are all 12 volt based systems. Because of the present invention’s design as a 24 volt system, it is designed specifically for DC powered aquarium pumps and does not require an inverter, or transformer like other prior art solutions.

One advantage of the design of the present invention over the prior art is that it uses the same pump that is connected to normal power as well as battery power by incorporating a 24 volt DC powered relay. The present invention does not use multiple pumps and no air pumps like other prior art system and results in a much simpler and direct component and installation compared to those currently offered and known in the prior art.

The present invention also uses an automatic power switch and an 8 point DPDT relay on a 10 amp circuit in comparison to the 6 point relays on 30 amp circuits known in the prior art.

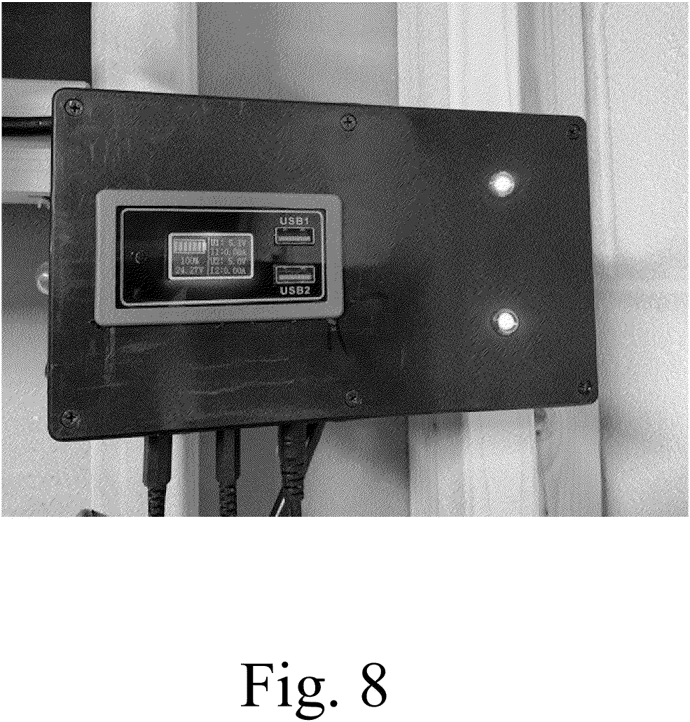

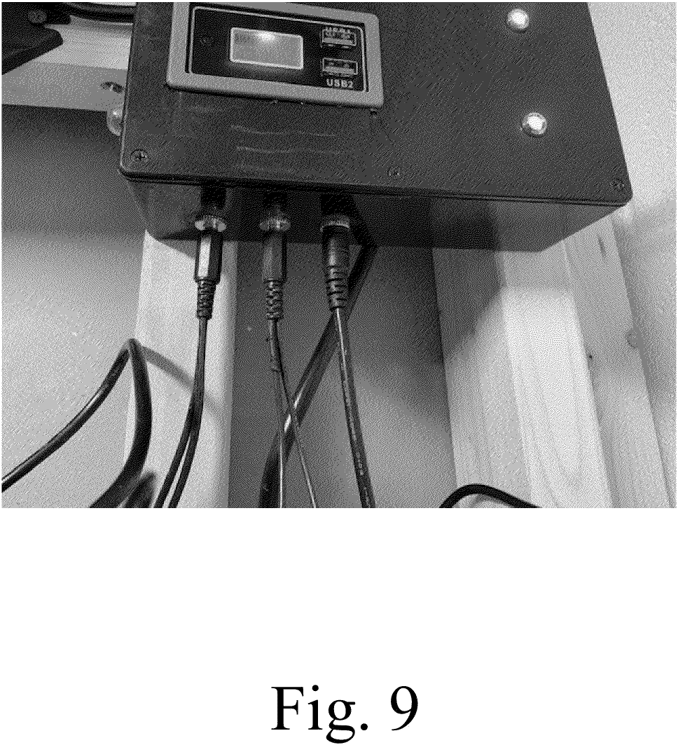

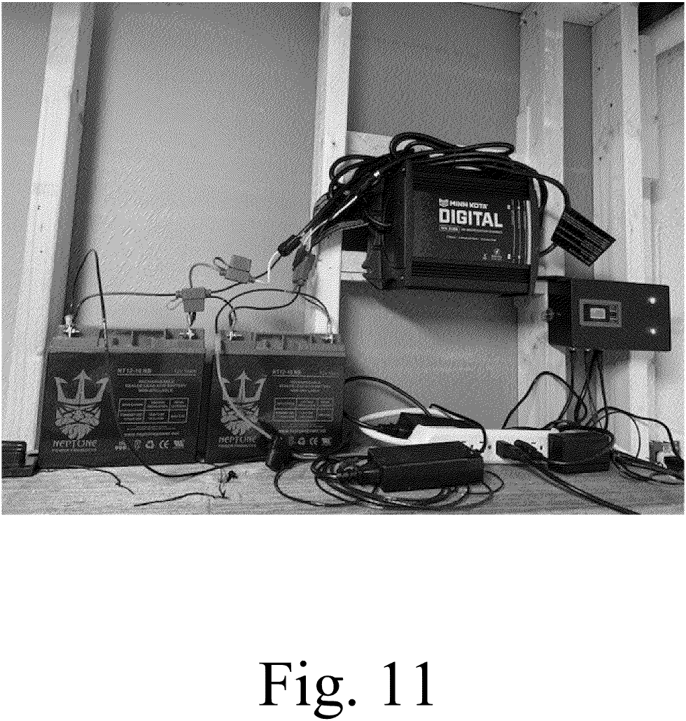

Now referring to FIGS. 8-11, the Backup Box as taught by the present invention is a box that contains 3 5.5x2.1 mm female DC power connectors. One for normal power one for battery power and one is output power. The normal power is powered by the pumps normal (power brick). The battery power is wired to the customer’s choice of an AH battery setup and then connected to the battery connector on the Backup Box. And the 3rd and final connector connects a cable from the Backup Box to the pump or power head.

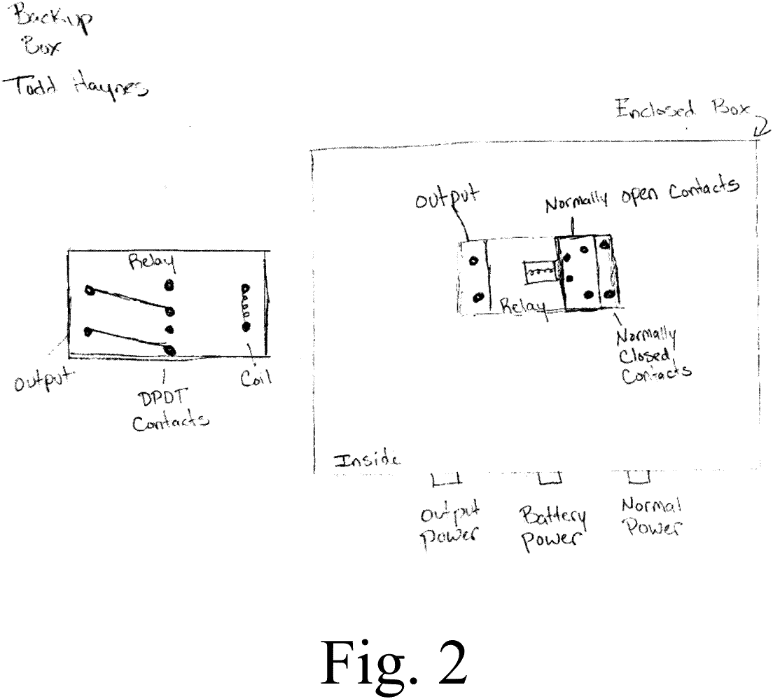

Now referring to FIGS. 2, 3, 5, 6, and 7, inside the Backup Box there is a 12-24 volt DC DPDT relay The normal power connects from the 5.5x2.1 mm connection to the Normally Open contacts on the relay. It also connects to the 12-24 volt coil that pulls the relay in when 12-24 volt DC power is applied. The Battery power from the customers AH battery setup connects on battery connection on the Backup Box which connects to the Normally Closed side of the relay. The output side of the DPDT relay connects to the output port on the Backup Box which connects to the pump or power head.

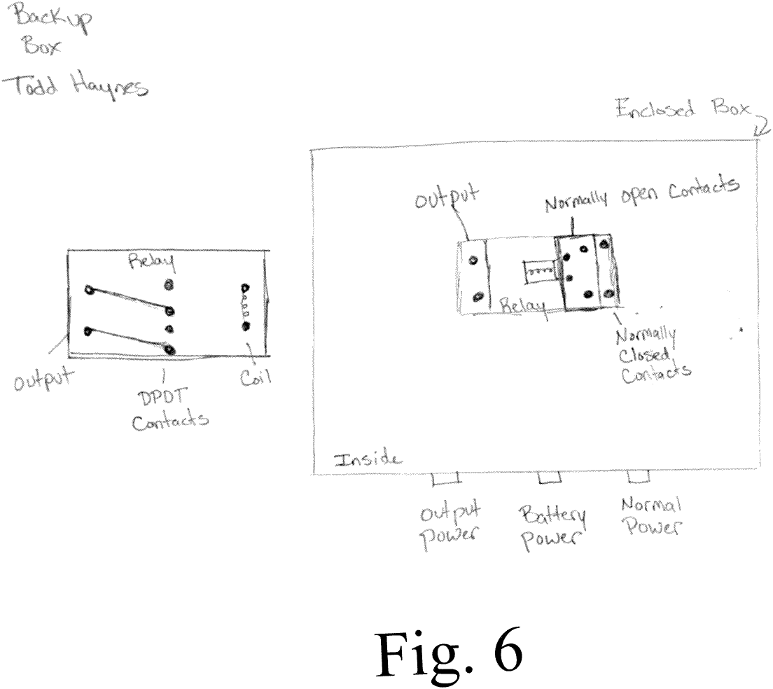

As shown in FIGS. 2 and 6, the relay is comprised of one or more output connections, one or more DPDT contacts, and a coil. The relay is located inside an enclosed box housing which retains all the components of the present invention. The relay has both normally open contacts and normally closed contacts.

The normal power connects from the 5.5x2.1 mm jack/connection to the Normally Open contacts on the relay. It also connects to the 12-24 volt coil that pulls the relay in when 12-24 volt DC power is applied. The Battery power from the customers AH battery setup connects on battery connection on the Backup Box which connects to the Normally Closed side of the relay. The output side of the DPDT relay connects to the output port on the Backup Box which connects to the pump or power head.

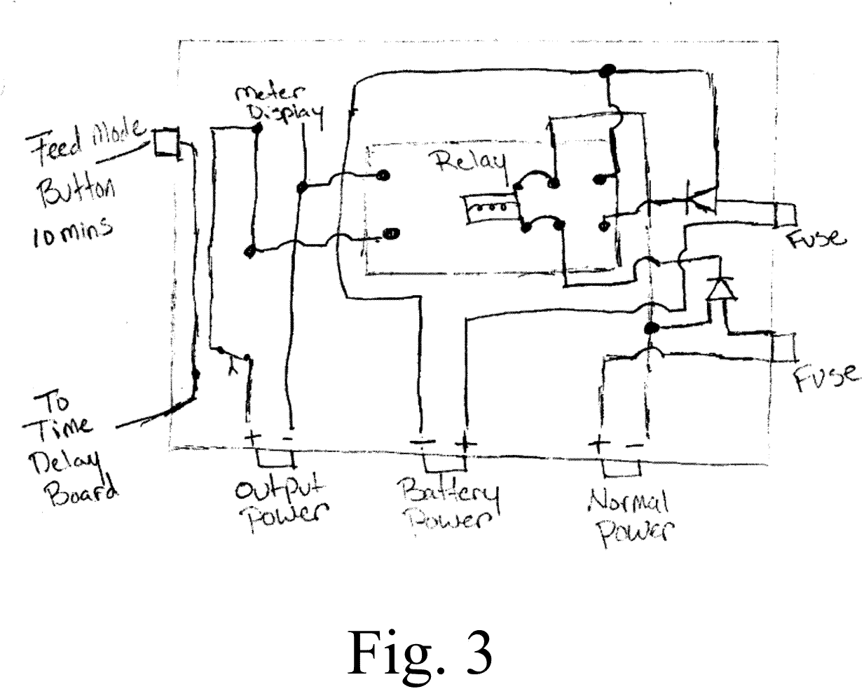

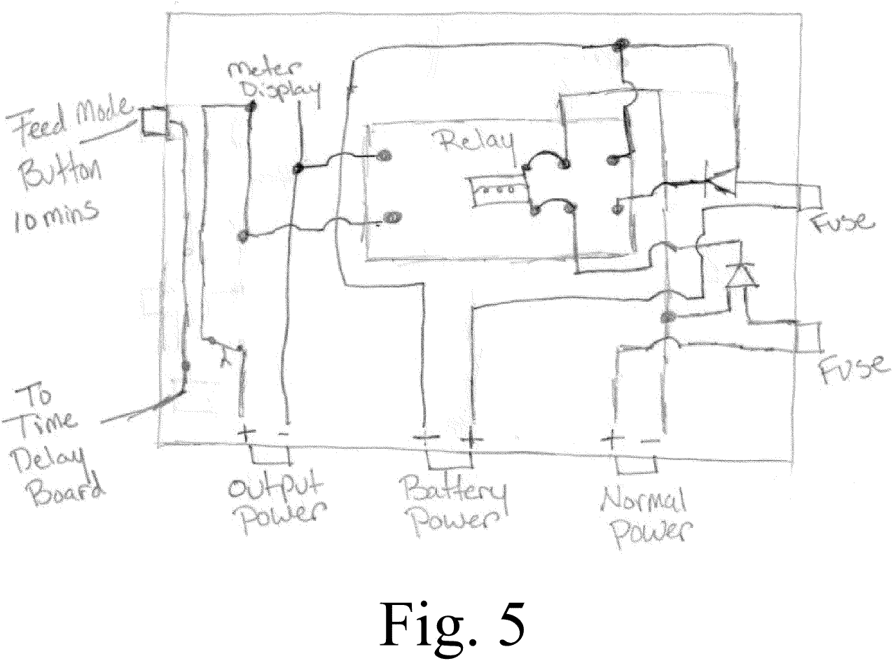

Now referring to FIGS. 3 and 5, additional wiring of the present invention is illustrated. Here it is shown that the relay out is connected to the meter output and output power. The Battery power from the customers AH battery setup connects on battery connection on the Backup Box which connects to the Normally Closed side of the relay. The output side of the DPDT relay connects to the output port on the Backup Box which connects to the pump or power head. Additionally, the feed mode button, typically set for 10 minutes, is connected to a time delay board for providing the feed mode functionality.

In use, when the Backup Box taught by the present invention has normal power applied to it, it energizes the 12-24 volt DC coil and closes the Normally Open side of the relay which sends 12-24 volts through the relay and to the connected pump or power head that is connected to the output port on the Backup Box. When normal power is lost the coil will DE-energize thus opening the Normally Open side of the relay in turn causing the Normally Closed side of the relay to close and send 12-24 volts DC battery power through the Normally Closed side of the relay through the fuse and to the Output connection on the Backup Box.

The Output connection on the Backup Box is common to both the Normally Open and Normally Closed terminals on the Relay depending on the state it is in. So, with a loss of power to the 12-24 volt coil the Backup Box will automatically change from normal “plugged in” power to the battery power with no effort from the user. So, no matter where they may be if the power goes out the aquarium will continue to run for however long the user has set up their AH battery setup. When normal power is restored, it will energize the coil and automatically switch back to normal “plugged in” power again with no effort from the customer. Then if the customers AH battery setup is equipped with a trickle charger and the power is restored it will automatically recharge the batteries again with no effort from the user.

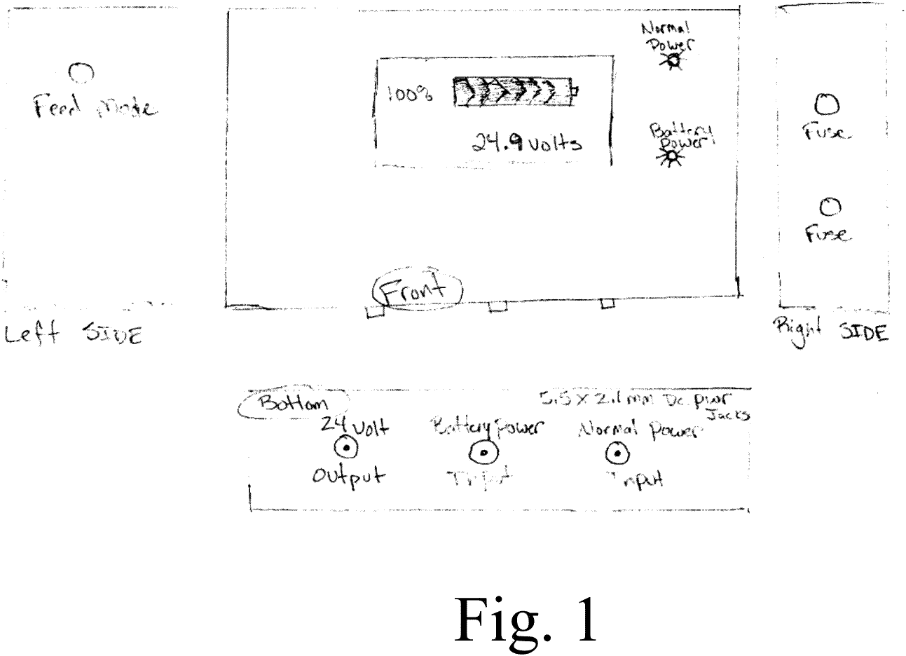

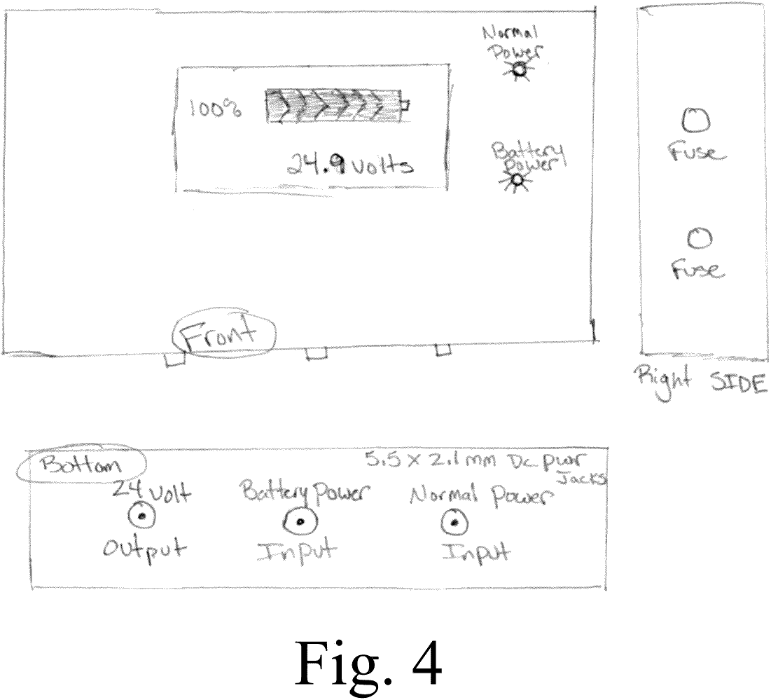

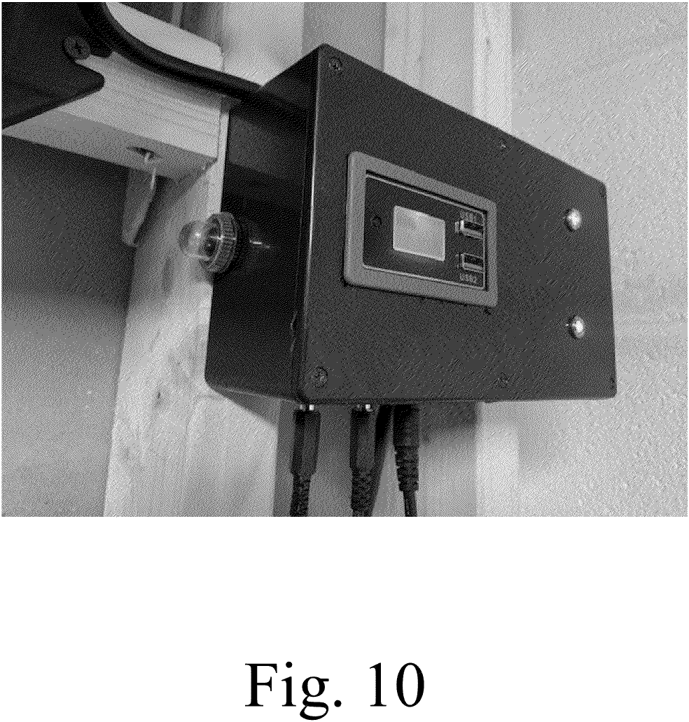

As shown in FIGS. 1, 4, and 8, the Backup Box as taught by the present invention contains a 12-24 volt battery meter display as well to let the user know how much the battery is charged. It also has an indicator light for both normal and battery power letting the user know that power is available for one or both power supplies. As shown in FIG. 10, on a left side when facing the front face with the display, a feed mode button is located for manually placing the box into a feed mode state. On a right side when facing the front face with the display, two fuses are located providing a fused connection to output connections. As shown in FIGS. 8-11, on a bottom side when facing the front face with the display, a 24 volt output, a battery power input, and a normal power input are provided, which are standard 5.5 x 2.1 mm DC power jacks/connectors.

The Battery setup is totally up to the user. A user can use a simple inexpensive 12-24 volt DC 7AH setup or they can make their setup more expensive and last 100’s of hours. The choice is theirs. This invention will make having backup power available in the event of a power outage affordable as well as easy.

With respect to the construction and physical components, all wiring is 14 gage THHN. All parts are rated for 10 Amps. There is a feed mode button on the side of the unit as shown in FIG. 10 to shut down output power for 10 Mins.

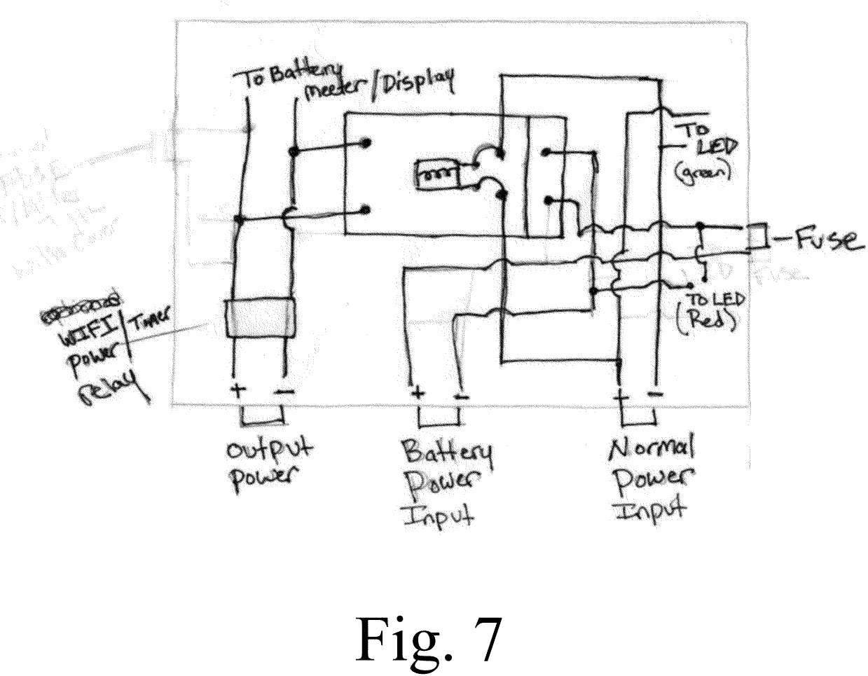

Now referring to FIG. 7, in an alternative embodiment, the present invention can also incorporate a WIFI module/power relay in the box which controls the feed mode and off modes. In this embodiment, the relay output is connected to the batter meter/display as well as the output power jack/connector of the battery backup box, and a WiFi module/power relay and timer are connected between the output power jack/connecter and the relay. In this embodiment, the normal power connects from the 5.5x2.1 mm jack/connection to the Normally Open contacts on the relay. A green LED light is used to provide a visual monitor of the normal power input status. It also connects to the 12-24 volt coil that pulls the relay in when 12-24 volt DC power is applied. The Battery power from the customers AH battery setup connects on battery connection on the Backup Box which connects to the Normally Closed side of the relay. A red LED light is used to provide a visual monitor of the batter power input status. The output side of the DPDT relay connects to the output port on the Backup Box which connects to the pump or power head. Finally, fuses a can be added to the normal power input and battery power input lines in combination or individually to provide additional protection to the relay and components as shown in FIGS. 3,5, and 7.

Thus, it is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. An automatic backup power controller for aquarium use, comprising:
a box for enclosing an electrical circuit and components;
the electrical components including:
a 12-24 volt DC DPDT relay;
three 5.5x2.1 mm female DC power connectors;
a first female DC power connector for normal power input;
a second female DC power connector for battery power input, and
a third female DC power connector for output power for connecting a cable from the device to a pump or power head.

2. The device of claim 1, wherein
the system is a 24 volt system.

3. The device of claim 1, wherein
the relay is a 24 volt DC powered relay.

4. The device of claim 3, wherein
The 24 volt system is designed specifically for DC powered aquarium pumps and does not require an inverter, or transformer like other prior art solutions.

5. The device of claim 1, wherein
the relay acts as an automatic power switch.

6. The device of claim 1, wherein
the relay is an 8 point DPDT relay on a 10 amp circuit.

7. The device of claim 1, wherein
the normal power is powered by the pumps normal (power brick).

8. The device of claim 1, wherein
the battery power is wired to the customer’s choice of an AH battery setup; and
the batter power is connected to the battery connector on the Backup Box.

9. The device of claim 1, wherein
the normal power connects from the 5.5x2.1 mm connection to the Normally Open contacts on the relay; and
the normal power also connects to the 12-24 volt coil that pulls the relay in when 12-24 volt DC power is applied.

10. The device of claim 1, wherein
the battery power from the customers AH battery setup connects on battery connection on the device which connects to the Normally Closed side of the relay.

11. The device of claim 1, wherein
the relay is comprised of
one or more output connections,
one or more DPDT contacts, and
a coil;
the relay is located inside an enclosed box housing which retains all the components of the present invention; and
the relay has both normally open contacts and normally closed contacts.

12. The device of claim 11, wherein
the relay out is connected to the meter output and output power;
the Battery power from the customers AH battery setup connects on battery connection on the Backup Box which connects to the Normally Closed side of the relay; and
the output side of the DPDT relay connects to the output port on the device which connects to the pump or power head.

13. The device of claim 1, further comprising
a feed mode button, typically set for 10 minutes, connected to a time delay board for providing a feed mode functionality.

14. The device of claim 1, wherein
when the device has normal power applied to it, it energizes the 12-24 volt DC coil and closes the Normally Open side of the relay which sends 12-24 volts through the relay and to the connected pump or power head that is connected to the output port on the device; and
when normal power is lost the coil will DE-energize thus opening the Normally Open side of the relay in turn causing the Normally Closed side of the relay to close and send 12-24 volts DC battery power through the Normally Closed side of the relay through the fuse and to the Output connection on the device.

15. The device of claim 1, wherein
the Output connection on the device is common to both the Normally Open and Normally Closed terminals on the Relay depending on the state it is in;
with a loss of power to the 12-24 volt coil the device will automatically change from normal “plugged in” power to the battery power with no effort from the user; and
when normal power is restored, it will energize the coil and automatically switch back to normal power again.

16. The device of claim 1, further comprising
a 12-24 volt battery meter display;
an indicator light for normal power; and
an indicator light for battery power.

17. The device of claim 1, further comprising
providing a fused connection to each of the input connections.

18. The device of claim 1, wherein
all wiring is 14 gage THHN; and
all parts are rated for 10 Amps.

19. The device of claim 1, further comprising
a WIFI module/power relay in the box which controls the feed mode and off modes; and
the WiFi module/power relay and timer are connected between the output power jack/connecter and the relay.
